(19) United States
(12) Patent Application Publication
(10) Pub. No.: US 2014/0033544 A1
(43) Pub. Date: Feb. 6, 2014

(54) Fruit Cutter

(71) Applicants: Carrie Cline, Milford, CT (US); Cynthia Mockler, North Haven, CT (US)

(72) Inventors: Carrie Cline, Milford, CT (US); Cynthia Mockler, North Haven, CT (US)

(21) Appl. No.: 13/958,556

(22) Filed: Aug. 3, 2013

Related U.S. Application Data
(60) Provisional application No. 61/679,408, filed on Aug. 3, 2012.

(51) Int. Cl. B26B 27/00

(52) U.S. Cl. CPC B26B 27/00
USPC 30/295

(57) ABSTRACT

A fruit cutter having a cutter greater than two inches in length having a predefined external profile. The cutter including a top portion and a bottom portion consisting of edges for cutting a fruit. The top portion including a profile and a palm guard carried by said top portion.

### FIELD OF INVENTION

The present invention relates to the industry which prepares fruit arrangements for special occasions and in particular to the creation of specialized cutters for cutting fruit.

### BACKGROUND

In the fruit arrangement industry, in order to increase productivity creative designs for fruit must be established and also a means for cutting multiple designs simultaneously. New designs for deep cutters are disclosed in addition to an innovative Palm Guard for assisting the operator in cutting the respective fruits utilizing the cutters. Finally, certain cutters have air holes in them to assist in cutting multiple sectioned fruit pieces.

### SUMMARY

A fruit cutter having a cutter greater than two inches in length having a predefined external profile. The cutter including a top portion and a bottom portion consisting of edges for cutting a fruit. The top portion including a profile and a palm guard carried by said top portion.

### BRIEF DESCRIPTION OF THE DRAWINGS

For a fuller understanding of the invention, reference should be made to the following detailed description, taken in connection with the accompanying drawings, which are not drawn to scale, in which:

FIG. 1 illustrates a perspective view of a cutter in the shape of a bird with an associated palm guard employed.

FIG. 2 illustrates a top view of a cutter in the shape of a bird with an associated palm guard employed;

FIG. 3 illustrates a review view of a cutter in the shape of a bird with an associated palm guard employed.

### DETAILED DESCRIPTION

As required, exemplary embodiments of the present invention are disclosed herein. These embodiments are meant to be examples of various ways of implementing the invention and it will be understood that the invention may be embodied in alternative forms. The figures are not to scale and some features may be exaggerated or minimized to show details of particular elements, while related elements may have been eliminated to prevent obscuring novel aspects. Therefore, specific structural and functional details disclosed herein are not to be interpreted as limiting, but merely as a basis for the claims and as a representative basis for teaching one skilled in the art to variously employ the present invention.

The various new cutter designs are intended for “deep” cuts. Meaning, they are intended for cutting multiple sections of fruit slices simultaneously producing multiple cut designs. In the fruit arrangement business, each individual fruit piece is hand assembled. An initial fruit piece is prepared, section and then subject to being cut into a specific shape. Due to the time required to prepare each individual arrangement, time saving methods are constantly being evaluated to assist the fruit arrangement makers in food preparation techniques enabling them to save time. Time saving is important as certain holidays such as Valentine's Day and Mother's Day are peak request periods for such fruit arrangements. The new cutter designs are deep, in some cases over three inches. Due to the depth of these devices and their utilization for cutting the equivalent three inches of fruit, extensive force is required by the fruit arrangement individual in cutting these fruit sections. It is important that the individuals can do these tasks in a repeated manner. Consequently, the fruit cutters are not extensively long, nor too shallow.

Additionally, the cutters are very sharp, but must also have high tolerance to provide for repeated use. The cutting edges while thin and sharp must depend from thick sidewalls. In the preferred embodiment the sides are 17 millimeters in thickness and the cutter is greater than two inches in length and preferably three inches in length. Such thickness provides for a sturdy device of such a long cutter.

Since these cutters are intended for industrial and commercial utilization, they must be sturdy and stand up to constant utilization. One area to increase sturdiness is to provide a planar top surface. The extra material at the top of the cutter provides stability and strength. An air hole is provided in the tops to allow air to pass as the cutter is passed through the fruit sections.

Since the device is a cutter and force is required to cut into multiple fruit sections, a palm guard has been designed. The palm guard is individually molded and attached to the top of the cutter. Preferably the palm guard is made from a substance such as polypropylene which is a hard plastic. When attached it is desirable that the palm guard is not removable.

Preferably, the palm guard is sized to cover the entire top plane of the cutter maintaining the air hole exposed. In this manner no sharp edges are present to engage an individual and the palm guard provides a surface area which is smooth and fairly sturdy while providing a cushion for an individual to exert force. Additionally, the palm guard is designed to correspond with the outer shape of the cutter, the cutter's design, to enable the individual to readily recognize which cutters of an entire inventory is which for easy and rapid selection.

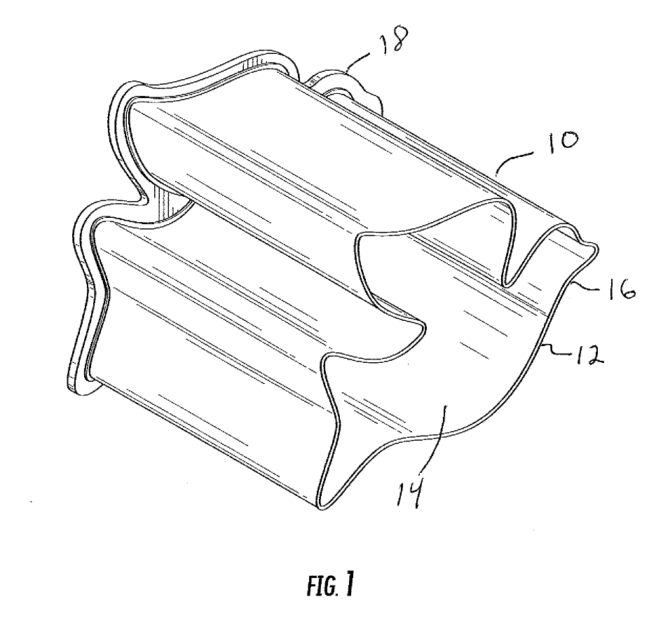

As shown in FIG. 1, a cutter body 10 is defined into an irregular outer periphery 12 defining a shape. In this case, a dove is illustrated. The outer periphery defines a central interior 14 for receiving fruit. The lowermost portion 16 defines a cutting blade which will engage a fruit piece sectioning the fruit article into the outer profile. Substantial quantities of fruit will be simultaneously cut such that a large quantity of fruit will pass into the interior of the cutter.

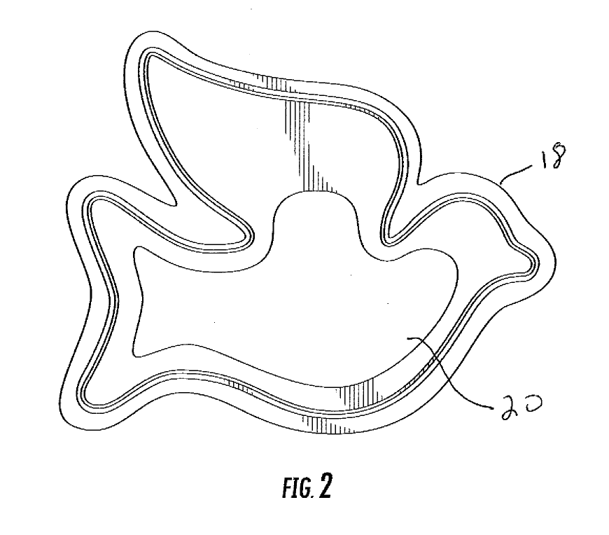

As shown in FIGS. 1 and 2, a palmguard 18 is carried by the upper portion of the cutter body. Preferably the palmguard 18 has a profile similar to the profile of the outer profile of the cutter body. The palmguard provides a planar surface for engaging a hand or other compressing force for forcing the lower cutting edge into the fruit. The palmguard removes the sharp corners of the top edge of the cutter from engaging a person. Furthermore, by resembling the overall appearance of the cutter, a person can quickly evaluate the design of the cutter. In operation of a fruit franchise industry, several cutters are employed and by having the appearance readily ascertainable by having the palmguard resemble the shape of the cut design, an operator can quickly and easily retrieve the desired cutter for the necessary cuts required to make a particular arrangement.

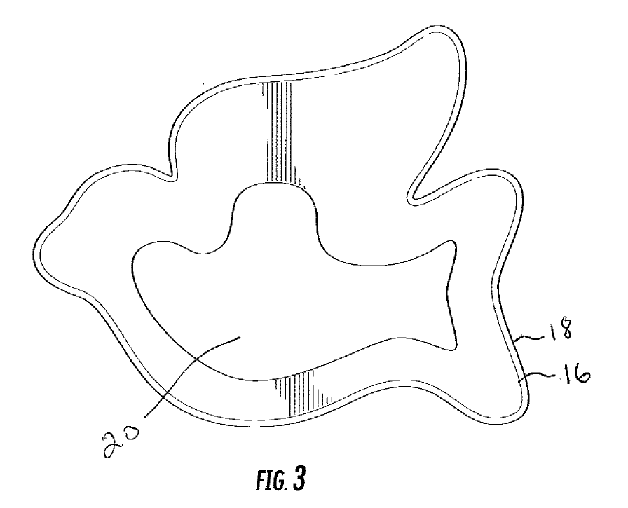

FIGS. 2 and 3 illustrate that the palmguard extends beyond the outer profile of the cutter body, and also extends substantially into the interior of the profile defined by the edges of the cutter's body. This provides for a large surface area for an operator to engage. Hence, not only is the upper most edges of the cutter blunted, but also a large contact area is provided. A central cavity 20 is defined within the palmguard body which facilitates in allowing the escape of air in the central body as fruit is positioned into the central interior as deep cuts are made into the respective fruit pieces. Additionally, ease of cleaning of the interior of the cutter is provided by providing for an open communication throughout the body's interior from both the top and bottom edges.

I claim:

1. A fruit cutter comprising:
a cutter greater than two inches in length having a predefined external profile, said cutter including a top portion and a bottom portion having a sharp edge for cutting a fruit;
said top portion including a profile; and
a palm guard carried by said top portion.

2. The fruit cutter of claim 1 wherein said palm guard has an outer profile resembling said external profile of said cutter.

3. The fruit cutter of claim 1 wherein said palm guard extends beyond said external profile of said cutter and also covers an interior portion of said profile.

4. The fruit cutter of claim 3 wherein said external profile defines a central interior cavity in communication with said sharp edge of said bottom portion enabling fruit to pass into the central interior was the edge cuts into the fruit.

5. The fruit cutter of claim 4 wherein said palm guard has a central cavity in communication with said central interior cavity of said cutter.
